(19) United States
(12) Patent Application Publication
(10) Pub. No.: US 2008/0221257 A1
(43) Pub. Date: Sep. 11, 2008

(54) Aqueous Dispersions And Their Use

(75) Inventors: Stefan Becker, Mannheim (DE); Hubertus Peter Bell, Mannheim (DE); Ulf Dietrich, Wachenheim (DE); Stephan Huffer, Ludwigshafen (DE); Matthias Kluglein, Ludwigshafen (DE); Darijo Mijolovic, Mannheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 11/997,230

(22) PCT Filed: Jul. 28, 2006
(86) PCT No.: PCT/EP2006/064801

§ 371 Date: Jan. 29, 2008

(30) Foreign Application Priority Data
Aug. 4, 2005 (EP) 05107216.3
May 29, 2006 (EP) 06114628.8

(51) Int. Cl. C08L 23/22; C09D 123/22

(52) U.S. Cl. 524/515

(57) ABSTRACT

The present invention relates to aqueous dispersions comprising
(A) at least one (co)polymer of at least one branched or straight-chain C₃-C₁₀-alkene,
(B) at least one emulsifies synthesized by
   (a) preparation of a (co)polymer of isobutene, the (co)polymer having at least one reactive group,
   (b) functionalization of the (co)polymer of at least one branched or straight-chain C₃-C₁₀-alkene,
   (c) incorporation of at least one hydrophilic unit.

The present invention relates to aqueous dispersions comprising
(A) at least one (co)polymer of at least one branched or straight-chain C₃-C₁₀-alkene,
(B) at least one emulsifier synthesized by
   (a) preparation of a (co)polymers of isobutene the (co)polymer having at least one reactive group,
   (b) functionalization of the (co)polymer of isobutene (a),
   (c) incorporation of at least one hydrophilic unit.

The present invention furthermore relates to a process for the preparation of aqueous formulations according to the invention and their use for the production of leather and of structures.

In most cases, structures should not allow moisture to pass through from the outside into the interior. It would therefore be particularly desirable if such buildings did not absorb moisture at all. Moisture can, for example, promote growth of algae and moss. Furthermore, moisture can result in the formation of cracks at temperatures around the freezing point: water can penetrate into small cavities, then freezes—for example overnight—and expands owing to the lower density of ice. The structure is mechanically damaged thereby.

Structures, such as, for example, masonry or concrete, are therefore rendered water-repellant in many cases for their protection. Water repellency can be imparted, for example, with one or more silicone compounds by incorporating silicone compound into one or more building materials and then carrying out construction. However, it is also possible to adopt a procedure in which the actual structure is first erected and water repellency is imparted subsequently. The last-mentioned process means an additional operation. Moreover, poorly accessible parts of the building are then generally not rendered water repellant or rendered only poorly water repellant and store moisture for a particularly long time, which can even lead to greater growth of algae and moss and to mold formation in the affected parts.

The procedure therefore widely adopted to date is to incorporate, for example stir, one or more hydrophobic substances into building materials. For this purpose, the hydrophobic substance or substances is or are preferably used as an aqueous formulation. In many cases, however, it is found that, when water repellants, such as, for example one or more silicone compounds, are stirred into building materials, such as, for example, concrete or mortar, the mechanical properties, such as, for example, the flexural tensile strength and the compressive strength, decrease. Such a reduction in mechanical properties of concrete and mortar are, however, unacceptable.

It is therefore the object to provide water repellents for building materials which firstly have a good water repellant effect and secondly the use thereof does not lead to a decrease in the mechanical properties, such as, for example, flexural tensile strength and compressive strength.

It is furthermore the object to provide further applications for aqueous formulations of hydrophobic substances.

Accordingly, the dispersions defined at the outset were found.

Dispersions according to the invention comprise
(A) at least one (co)polymer of at least one branched or straight-chain C₃₋C₁₀-alkene,
(B) at least one emulsifier synthesized by
   (a) preparation of a (co)polymer of isobutene, the (co)polymer having at least one reactive group,
   (b) functionalization of the (co)copolymer of isobutene (a),
   (c) incorporation of at least one hydrophilic unit.

In the context of the present invention, the term dispersions includes emulsions, suspensions and liquids having the appearance of clear solutions.

Suitable (co)polymers of at least one branched or straight-chain C₃-C₁₀-alkene (A), also referred to as (co)polymer (A) in the present invention, are homopolymers and copolymers of propylene or of straight-chain or preferably branched C₃-C₁₀-olefins. Homopolymers of propylene, isobutene, 1-pentene, 2-methyl-butene, 1-hexene, 2-methyl-1-pentene, 2-methyl-1-hexene, 2,4-dimethyl-1-hexene, diisobutene (mixture of 2,4,4-trimethyl-1-pentene and 2,4,4-trimethyl-2-pentene), 2-ethyl-1-pentene, 2-ethyl-1-hexene and 2-propyl-heptene, 1-octene, 1-decene and 1-dodecene may be mentioned by way of example, homopolymers of isobutene, diisobutene and 1-dodecene being very particularly preferred. (Co)polymers (A) may have, per molecular, one ethylenically unsaturated group which may be present in the form of a vinyl, vinylidene or alkylvinylidene group.

Copolymers of the abovementioned C₃-C₁₀-alkenes with one another or with up to 20% by weight, based on relevant copolymer (A), of vinylaromatics, such as styrene and α-methylstyrene, C₁-C₄-alkylstyrene, such as, for example, 2-, 3- and 4-methylstyrene and 4-tert-butylstyrene, may be mentioned by way of example as copolymers (A).

In an embodiment of the present invention, (co)polymer (A) has an average molecular weight Mₙ of up to 50 000 g/mol, preferably from 300 to 25 000 g/mol, particularly preferably from 400 to 10 000 g/mol, very particularly preferably from 500 to 5000 g/mol and even more preferably up to 1200 g/mol.

Preferred (co)polymers (A) are polypropylenes and polyisobutenes having an average molecular weight Mₙ of up to 50 000 g/mol, preferably from 300 to 25 000 g/mol, particularly preferably from 400 to 10 000 g/mol, very particularly preferably from 500 to 5000 g/mol and even more preferably up to 1200 g/mol, for example determined by means of gel permeation chromatography (GPC).

In an embodiment of the present invention, (co)polymers (A) have a polydispersity M_{w}/Mₙ in the range of from 1.1 to 10, preferably up to 3 and particularly preferably from 1.5 to 2.0.

In an embodiment, (co)polymers (A) have a monomodal molecular weight distribution. In another embodiment of the present invention, (co)polymers (A) have a multimodal and in particular a bimodal molecular weight distribution with a maximum of Mₙ in the range of from 500 to 1200 g/mol and a local maximum of Mₙ in the range of from 2000 to 50 000 g/mol, particularly preferably up to 10 000 g/mol.

(Co)polymers (A) and in particular polypropylenes and polyisobutenes are known as such. Polyisobutenes are preferably obtainable by polymerization of isobutene in the presence of a Lewis acid catalyst, such as, for example, of a boron trifluoride catalyst, cf. for example DE-A 27 02 604. Suitable isobutene-containing starting materials are both isobutene itself and isobutene containing C₄-hydrocarbon streams, for example C₄-raffinates, C₄-cuts from the dehydrogenation of isobutane, C₄-cuts from steam crackers or so-called FCC crackers (FCC: fluid catalyzed cracker), provided that relevant C₄-cuts have been substantially freed from 1,3-butadiene present therein. In many cases, the concentration of isobutene in C₄-hydrocarbon streams is in the range of from 40 to 80% by weight. Suitable C₄-hydrocarbon streams should as a rule comprise less than 500 ppm, preferably less than 200 ppm, of 1,3-butadiene.

The preparation of further (co)polymers (A) is known per se; methods are to be found, for example, in WO 96/23751 and in WO 99/67347, example 3.

Dispersions according to the invention furthermore comprise at least one emulsifier (B), which can be prepared by a multistage process.

Emulsifier (B) is preferably obtained as follows. First, a (co)polymer of isobutene is prepared in a first stage (a), the (co)polymer having at least one reactive group, also referred to as (co)polymer (a) in the context of the present invention, i.e. (co)polymer (a) has at least one reactive group, for example two reactive groups, and preferably one reactive group per molecule.

Olefinic double bonds which may be present in the form of a vinyl, vinylidene or alkylvinylidene group are preferred as reactive groups. Vinyl groups and isobutenyl groups are particularly preferred.

Suitable (co)polymers (a) are homo- and copolymers of isobutene, homo- and copolymers of dimers or oligomers of isobutene being included, for example homo- and copolymers of diisobutene (mixture of 2,4,4-trimethyl-1-pentene and 2,4,4-trimethyl-2-pentene).

Polyisobutenes having an average molecular weight Mₙ of up to 2500 g/mol, preferably in the range of from 300 to 1200 g/mol, particularly preferably of at least 400 g/mol, very particularly preferably of at least 500 g/mol, for example determined by means of gel permeation chromatography (GPC), may be mentioned as particularly preferred (co)polymers (a).

In an embodiment of the present invention, (co)polymers (a) have a polydispersity M_{w}/Mₙ in the range of from 1.1 to 10, preferably up to 3 and particularly preferably from 1.5 to 2.0.

The preparation of polyisobutenes particularly preferred as (co)polymers (a) is known and is described in detail, for example, in WO 04/9654, pages 4 to 8, or in WO 04/35635, pages 8 to 10.

In an embodiment of the present invention, (co)polymers (a) have a monomodal molecular weight distribution. In another embodiment of the present invention, (co)polymers (a) have a multimodal and preferably a bimodal molecular weight distribution with a maximum of Mₙ in the range of from 500 to 1200 g/mol and a local maximum of Mₙ in the range of from 2000 to 5000 g/mol.

Emulsifier (B) present in aqueous dispersions according to the invention incorporates at least one hydrophilic unit, for example a polyalkylene glycol unit or a polyethylenimine unit. In order to incorporate the hydrophilic unit or the hydrophilic units, (co)polymer (a) is functionalized in a second stage (b). Preferred embodiments of the functionalization of (co)polymer (a) comprise:
i) reaction with aromatic hydroxy compounds in the presence of an alkylation catalyst to obtain aromatic hydroxy compounds alkylated with (co)polymer (a); very particularly preferred phenolic compounds are those having 1,2 or 3 OH groups, it being possible, if appropriate, for the relevant phenolic compounds to have at least one further substituent. Preferred further substituents are C₁-C₈-alkyl groups and in particular methyl and ethyl. Particularly preferred compounds are those of the general formula

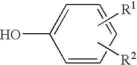

where R¹ and R², independently of one another, are hydrogen, OH or CH₃. Phenol, the cresol isomers, catechol, resorcinol, pyrogallol, fluoroglucinol and the xylenol isomer are particularly preferred. In particular, phenol, o-cresol and p-cresol are used. If desired, mixtures of the abovementioned compounds may also be used for the alkylation.
ii) reaction of (co)polymer (a) with an equimolar amount of peroxy compound to obtain an epoxidized polyisobutene (b),
iii) reaction of a (co)polymer (a) with an alkene which has a double bond substituted by one or preferably more electron-attracting groups (enophile), in an ene reaction,
iv) reaction of (co)polymer (a) with carbon monoxide and hydrogen in the presence of a hydroformylation catalyst to obtain a hydroformylated polyisobutene (b),
v) reaction of (co)polymer (a) with a phosphorus halide or a phosphorus oxychloride to obtain a polyisobutene (b) functionalized with phosphonyl groups,
vi) reaction of (co)polymer (a) with a borane and subsequent oxidative cleavage to obtain hydroxylated polyisobutene (b),
vii) reaction of (co)polymer (a) with SO₃, free or masked, preferably acetyl sulfate or oleum to obtain a functionalized polyisobutene (b) having a terminal sulfo group,
viii) reaction of the (co)polymer (a) with oxides of nitrogen and subsequent hydrogenation to obtain a functionalized polyisobutene (b) having terminal amino groups.

Regarding details for carrying out the abovementioned reactions, we refer, for example, to WO 04/35635, pages 11 to 27.

For functionalization of the (co)polymer of isobutene (a) in an ene reaction, an alkene referred to as ene and having an allyl hydrogen atom is reacted with an alkene which has a double bond substituted by one or preferably more electron-attracting groups (enophile) in a pericyclic reaction, comprising a carbon-carbon bond formation, a double bond shift and a hydrogen transfer. Here, (co)polymer of isobutene (a) reacts as an ene. Suitable enophiles are compounds which can also be used as dienophiles in the Diels-Alder reaction. Particularly suitable enophiles are fumaroyl dichloride fumaric acid, maleoyl dichloride, maleic anhydride and maleic acid, preferably maleic anhydride and maleic acid. The succinic acid derivatives of the general formulae Ia, Ib or Ic, in which R³ is a polyisobutene group having a number average molecular weight Mₙ of from 300 to 2500 g/mol, preferably from 400 to 1200 g/mol, particularly preferably at least 500 g/mol, form.

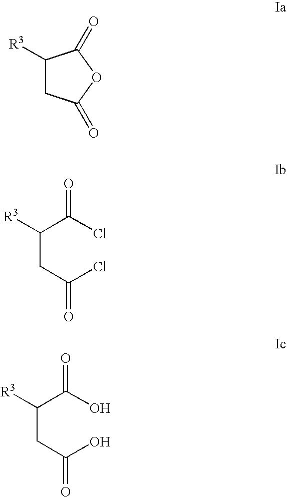

A very particularly preferably used enophile is maleic anhydride. With succinic anhydride groups, functionalized polyisobutenes (polyisobutenylsuccinic anhydride, PIBSA) of the formula Ia, as disclosed in EP-A 0 156 310, result.

The ene reaction can, if appropriate, be carried out in the presence of a Lewis acid as a catalyst. For example, aluminum chloride and ethyl-aluminum chloride are suitable.

Functionalization of a (co)polymer (a) gives functionalized polyisobutene (b), in which at least one hydrophilic unit is incorporated in a further step (c). For introducing the hydrophilic unit(s), the functionalized polyisobutene (b) is reacted either with alkylene oxides by means of graft polymerization or in a polymer-analogous reaction with polyalkylene oxide or polyethylenimine, depending on the type of their polar group(s). The route to be chosen depends on the type of functionalization of the (co)polymer of isobutene (a).

Preferably used alkylene oxides for reaction with functionalized polyisobutene (b) are ethylene oxide or ethylene oxide/propylene oxide mixtures, for example having a proportion of from 0 to 50% by weight of propylene oxide, preferably having a proportion of from 0 to 20% by weight of propylene oxide, particularly preferably ethylene oxide. The resulting alkylene oxide block may be a random copolymer, a gradient copolymer, an alternating or a block copolymer of ethylene oxide and propylene oxide. In addition to ethylene oxide and propylene oxide, the following pure alkylene oxides or mixtures may be used: 1,2-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 2,3-hexene oxide, 3,4-hexene oxide, 2-methyl-1,2-pentene oxide, 2-ethyl-1,2-butene oxide, 3-methyl-1,2-pentene oxide, decene oxide, 4-methyl-1,2-pentene oxide, styrene oxide or a mixture of oxides of industrially available raffinate streams.

Polyalkylene oxides and/or polyethylenimines can be used for the polymer-analogous reaction. Polyalkylene oxides based on ethylene oxide, propylene oxide, butylene oxide or further alkylene oxides are preferred. The following pure alkylene oxides or mixtures may serve as further alkylene oxides: 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 2,3-hexene oxide, 3,4-hexene oxide, 2- methyl-1,2-pentene oxide, 2-ethyl-1,2-butene oxide, 3-methyl-1,2-pentene oxide, decene oxide, 4-methyl-1,2-pentene oxide, styrene oxide or mixtures of oxides which are formed from industrially available raffinate streams. Furthermore, diglycerol, polyglycerol and/or poly-THF may be used.

Monoalkyl-capped polyalkylene glycol is preferably a polyalkylene glycol which is prepared by reacting C₁-C₂₀-alkanol with one or more alkylene oxides, in particular by reacting n-C₁-C₄-alkanol, such as, for example, n-butanol, n-propanol, ethanol and in particular methanol. Alkylene oxides which may be mentioned in particular are C₂-C₆-alkylene oxides, such as, for example, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 2,3-hexene oxide, 3,4-hexene oxide, 2-methyl-1,2-pentene oxide, 2-ethyl-1,2-butene oxide, 3-methyl-1,2-pentene oxide, epichlorohydrin, glycidyl alcohol, propylene oxide and in particular ethylene oxide, but also cyclic ethers, such as, for example, tetrahydrofuran. Preferred polyalkylene oxides are those which can be prepared by reacting n-C₁-C₄-alkanol with ethylene oxide or propylene oxide or ethylene oxide and propylene oxide, it being possible to use the different alkylene oxides simultaneously or sequentially where it is desired to react a plurality of alkylene oxides.

In an embodiment of the present invention, polyalkylene oxide has an average molecular weight (number average) in the range of from 150 to 50 000 g/mol, preferably in the range of from 200 to 30 000 g/mol, particularly preferably in the range of from 500 to 15 000 g/mol, very particularly preferably in the range of from 800 to 15 000 g/mol.

In an embodiment of the present invention, polyethylenimine has a number average molecular weight in the range of from 300 to 20 000 g/mol, preferably from 500 to 10 000 g/mol, very particularly preferably up to 5000 g/mol.

In an embodiment of the present invention, monoalkyl-capped polyalkylene glycol from step (c) has on average (number average) from 5 to 1000 alkylene oxide units per molecule, preferably from 10 to 550 alkylene oxide units per molecule.

Monoalkyl-capped polyalkylene oxide is more preferably polyethylene glycol capped with methyl or ethyl.

In an embodiment of the present invention the following reaction will be carried out for incorporating at least one hydrophilic unit into a functionalized (co)polymer of isobutene (b):
α) graft polymerization with at least one abovementioned alkylene oxide to obtain a (co)polymer of isobutene (b) functionalized with two succinic ester groups (per succinic anhydride group),
β) hydrolysis to obtain a (co)polymer of isobutene (b) functionalized with succinic acid groups, after which the succinic acid groups are reacted with alkylene oxide by means of graft polymerization as under α),
γ) reaction with maleic anhydride to give a product having two succinic anhydride groups at the chain end (so-called PIBBSA) and, if appropriate, hydrolysis, after which the succinic acid groups are reacted with alkylene oxide by means of graft polymerization as under α) or β),
δ) reaction with at least one amine to obtain a (co)polymer of isobutene (b) which is at least partly functionalized with succinimide groups and/or succinamide groups, which (co)polymer is subjected to a further reaction with alkylene oxide by means of graft polymerization,
ε) reaction with at least one alcohol or thioalcohol to obtain a (co)polymer of isobutene (b) functionalized with succinic ester groups or succinic thioester groups, which (co)polymer is subjected to a further reaction with said alkylene oxide by means of graft polymerization,
ζ) reaction with at least one polyethylenimine to obtain a (co)polymer of isobutene (b) which is at least partly functionalized with succinimide groups and/or succinamide groups,
η) reaction with at least one polyalkylene oxide which has at least one hydroxyl group to obtain a (co)polymer of isobutene (b) which is at least partly with succinic ester groups,
θ) reaction with at least one polyalkylene oxide which has at least one amino group to obtain a (co)polymer of isobutene (b) which is at least partly functionalized with succinimide groups and/or succinamide groups,
κ) reaction with at least one polyalkylene oxide which has at least one thiol group to obtain a (co)polymer of isobutene (b) which is at least partly functionalized with succinic thioester groups,
λ) if, after reaction of the succinic anhydride group, free carboxyl groups are still present, they can also be converted into salts. Preferred cations are in particular alkali metal cations, ammonium ions and alkylammonium ions.
μ) reaction with at least one monoalkyl-capped polyethylene glycol,

### Re γ):

The polyisobutenes derivatized with one succinic anhydride group per chain end can be subjected to an exhaustive ene reaction with an excess of maleic anhydride to give polyisobutenes functionalized with partly two succinic anhydride groups per chain end. The polyisobutenes thus functionalized can he reacted with alkylene oxides by means of graft polymerization, in each case, two succinic ester groups forming per anhydride group.

### Re δ) and ε)

Succinic anhydride groups can be reacted with polar reactants, such as alcohols, thioalcohols or amines, for further functionalization. Suitable polar reactants are preferably alcohols R⁴OH, thioalcohols R⁴SH or primary amines R⁴NH₂ or secondary amines R⁴R⁵NH, where R⁴ and R⁵, independently of one another are selected from linear and branched saturated hydrocarbon radicals which carry at least two substituents selected from the OH, SH, NH₂ or NH₃⁺ group and, if appropriate, one or more CH(O)-groups and, if appropriate, have non-neighboring oxygen atoms and/or —NH— and/or tertiary ammonium groups. Both the carboxyl groups of the anhydride may react, or else only one while the other carboxyl group is present as a free acid group or as a salt, in a further reaction, the free substituents (substituents which are not reacted with anhydride) or free carboxyl groups are alkoxylated.

### Re ζ:

It is possible to subject the succinic anhydride groups to a polymer-analogous reaction with polyethylenimines, one or more polyisobutene chains being linked to a polyethylenimine chain, depending on the reaction procedure. The bonding takes place via succinimide groups and/or succinamide groups.

### Re η), θ) and κ):

The succinic anhydride groups can be subjected to a polymer-analogous reaction with polyalkylene oxides. The polyalkylene oxides used must have at least one group selected from OH, SH, NH₂ or NH.

### Re μ):

The reaction of functionalized (co)polymer of step (b) with monoalkyl-capped polyalkylene glycol can be carried out in the presence of a catalyst, for example in the presence of acid or base. In some cases it may be expedient to carry out the reaction of functionalized (co)polymer from step (b) with monoalkyl-capped polyalkylene glycol in the presence of one or more dehydrating agents, for example sulfuric acid or a molecular sieve. In some cases, it may furthermore be expedient to carry out the reaction of functionalized (co)polymer from step (b) with monoalkyl-capped polyalkylene glycol with heating in a solvent or preferably in the absence of a solvent. For example, reaction temperatures of from 80 to 150° C. are suitable.

In an embodiment of the present invention, in emulsifier (B), (co)polymer (a) and monoalkyl-capped polyalkylene glycol in step (c) are chosen so thai their molecular weights Mₙ are in each case in the range of from 300 to 3000 g/mol, preferably from 500 to 1200 g/mol.

In a special embodiment of the present invention, polyalkylene oxides used in step (c) comprise the following structural units:
—(CH₂)₂—O—, —(CH₂)₃—O—, —(CH₂)₄—O—, —CH₂—CH(R⁶)—O—, —CH₂—CHOR⁷—CH₂—O—, where R⁶ is selected from C₁-C₂₄-alkyl
and R⁷ from hydrogen, C₁-C₂₄-alkyl, R⁹—C(═O) and R⁹—NH—C(═O).

The abovementioned structural units can be arranged so as to result in homopolymers or random copolymers, gradient copolymers or alternating or block polymers.

In a variant of the present invention, one or more compounds of the formula II are incorporated as hydrophilic unit(s) in step (c):

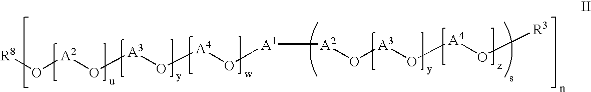

in which the variables, independently of one another, have the following meaning:
R⁶: hydrogen, C₁-C₂₄-alkyl, R⁶—C(═O), R⁶—NH—C(═O), polyalcohol radical;
R⁹: hydrogen, C₁-C₂₄-alkyl, R⁶—C(═O), R⁶NH—C(═O);
A² to A⁴: —(CH₂)₂—, —(CH₂₎₃—, —(CH₂)₄, —CH₂—CH(R⁶)—, —CH₂—CHOR⁷—CH₂—;
A¹: —C(═O)—O, —C(═O)-D-C(═O)—O, —CH₂—CH(—OH)-D-CH(—OH)—CH₂—O, —C(═O)—NH-D-NH—C(═O)—O;

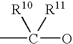

D: —(CH₂)—, arylene, optionally substituted;
R¹⁰, R¹¹: hydrogen, C₁-C₂₄-alkyl, C₁-C₂₄-hydroxyalkyl, benzyl or phenyl;
n 1, if R⁸ is not a polyalcohol radical, or in the range of from 1 to 500, if R⁸ is a polyalcohol radical,
s an integer in the range from 0 to 1000,
t an integer in the range from 1 to 12,
u an integer in the range from 1 to 2000,
v an integer in the range from 0 to 2000,
w an integer in the range from 0 to 2000,
x an integer in the range from 0 to 2000,
y an integer in the range from 0 to 2000,
z an integer in the range from 0 to 2000.

Branched or straight-chain C₁C₂₄-alkyl radicals, preferably methyl, ethyl, n-propyl, isopropyl, n-butyl, 1-methylpropyl, 2-methylpropyl, tert-butyl n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or n-eicosyl, may be mentioned as C₁C₂₄-alkyl radicals for R⁶, R¹⁰ and R¹¹.

Branched of straight-chain C₁-C₁₂-alkyl radicals, particularly preferably C₁-C₆-alkyl radicals, may be mentioned as preferred representatives of the abovementioned alkyl radicals.

Among polyalcohol radicals, radicals which are derived from, for example, glycerol, trimethylolpropane, pentaerythritol, glucose, sucrose, carbohydrates, polyvinyl alcohols, starch or starch hydrolysis products may be mentioned in particular.

In a further embodiment, polyalkylene oxide may be monoester polyethylene oxide (ester is, for example, R¹²—(C(═O)—, where R¹²═C₄-C₂₄-alkyl). monoaminopolyethylene oxide, monothiopolyethylene oxide or diaminopolyethylene oxide (cf. JP-A-09272796, PEO-diamine), etc.

Branched homo- or copolymers may also be incorporated as a hydrophilic unit. Branched homo- or copolymers can be prepared by subjecting several equivalents of ethylene oxide and, if appropriate, also propylene oxide and/or butylene oxide to an addition reaction, for example with polyalcohol radicals, e.g. with glycerol, trimethylolpropane, pentaerythritol, glucose, sucrose, carbohydrates, polyvinyl alcohols or starch and starch hydrolysis products or with sugar alcohols, such as sucrose, D-sorbitol and D-mannitol, or with polysaccharides, such as cellulose and starch. The alkylene oxide blocks may be randomly distributed, in a gradient distribution or present alternately or sequentially.

It is also possible to use polyesters of polyalkylene oxides and aliphatic or aromatic dicarboxylic acids, e.g. oxalic acid, succinic acid, adipic acid and terephthalic acid, having molecular weights(weight average) in the range of from 1500 to 25 000 g/mol, as described, for example, in BP-A-0 743 962, as a hydrophilic unit.

Furthermore, it is also possible to use polycarbonates, prepared by reacting polyalkylene oxides with phosgene or carbonates, such as, for example, diphenyl carbonate, and polyurethanes, prepared by reacting polyalkylene oxides with aliphatic and aromatic diisocyanates, as the hydrophilic unit.

Furthermore, homo- and copolymers of polyalkylene oxide-containing ethylenically unsaturated monomers, such as, for example, polyalkylene oxide (meth)acrylates, polyalkylene oxide vinyl ethers, polyalkylene oxide (meth)acrylamides, polyalkyleneoxide allylamines and polyalkylene oxide vinylamines, can also be used as polyalkylene oxides.

Of course, copolymers of the abovementioned polyalkylene oxide-containing ethylenically unsaturated monomers with other ethylenically unsaturated monomers can also be used.

Reaction products of polyethylenimines with alkylene oxides may also be used as the hydrophilic unit. Preferably used alkylene oxides in this case are ethylene oxide, propylene oxide, butylene oxide and mixtures of the abovementioned alkylene oxides, particularly preferably ethylene oxide. Polyethylenimines which may be used are polymers having number average molecular weights of from 300 to 20 000 g/mol, preferably from 500 to 10 000 g/mol, very particularly preferably up to 5000 g/mol. The weight ratio of alkylene oxide and polyethylenimine used may be in the range of from 100:1 to 0.1:1, preferably in the range of from 50:1 to 0.5:1, very particularly preferably in the range of from 20:1 to 0.5:1.

For the preparation of the hydrophilic units, in many cases alkoxylation catalysts are used. This is true regardless of whether the relevant hydrophilic unit is built up by grafting or is introduced by a polymer-analogous reaction. Alkoxylation catalysts which may be used are bases, for example alkali metal hydroxides or alkali metal alcoholates, but also Lewis acids, for example BF₃, SbCl₅, SnCl₄.2 H₂O, BF₃.H₃BO₄ or BF₃ dietherate. Particularly suitable alkoxylation catalysts are double hydroxide clays such as hydrotalcite, which may be modified as described in DE-A 43 25 237.

Depending on the choice of the alkoxylation catalyst, in each case specific properties of the hydrophilic units result, in particular with regard to the distribution of the degree of alkoxylation. Thus, with the use of the last-mentioned double hydroxide clays, alkoxylation products having a narrow molecular weight distribution or homologue distribution are obtained, which alkoxylation products are particularly suitable in some cases for use in the aqueous dispersions according to the invention.

The advantageous properties described above, in particular with regard to the degree of alkoxylation, are also achieved by using double metal cyanide (DMC) compounds, as described, for example, in DE-A 102 43 361, as alkoxylation catalysts.

In an embodiment of the present invention, emulsifier (B) has a structure of the empirical formula AₚB_{q}, where p and q, independently of one another, are integers in the range of from 1 to 8 and A is a functionalized (co)polymer of isobutene and B is a hydrophilic unit.

In a preferred embodiment of the invention, emulsifier (B) has a three-block structure ABA.

Particularly preferred emulsifiers (B) are two-block copolymers AB and three-block copolymers ABA, composed of PIBSA as block A and of polyethylene oxide or monoalkylpolyethylene oxide as hydrophilic block B.

Ian embodiment of the present invention, in aqueous dispersions according to the invention, the particles of co(polymer) A have a mean particle diameter in the range of from 0.1 to 10 μm, preferably from 0.25 to 0.75 μm measured, for example, by hydrodynamic flow analysis.

Aqueous dispersions according to the invention preferably comprise less than 1% by weight, particularly preferably less than 0.1% by weight, of further emulsifiers differing from emulsifier (B).

In an embodiment of the present invention, those emulsifiers (B) which have a free carboxyl group may be present in a form partly or completely neutralized with base. Examples of suitable bases are organic amines, such as, for example, triethylamine or N,N-diethanolamine, and furthermore ammonia. Preferred bases are basic alkali metal or alkaline earth metal compounds, such as, for example, hydroxides or bicarbonates of sodium, potassium, magnesium or calcium and carbonates of sodium and potassium.

In an embodiment of the present invention, aqueous dispersions according to the invention comprise
from 0.1 to 50% by weight, preferably from 10 to 30% by weight, very particularly preferably from 20 to 30% by weight, of (co)polymer (A),
from 0.1 to 30% by weight, preferably from 1 to 20% by weight, very particularly preferably from 1.5 to 10% by weight, of emulsifier (B),
it being possible for the remainder to be, for example, water.

In an embodiment of the present invention, the proportion of (co)polymer (A) is greater than that of emulsifier (B) in an aqueous dispersion according to the invention.

In a preferred embodiment of the present invention, the weight ratio of emulsifier (B) to (co)polymer (A) is in the range of from 1:1.01 to 1:50, preferably from 1:1.1 to 1:5.

In an embodiment of the present invention, aqueous dispersions according to the invention have a solids content in the range of from 0.2 to 80% by weight, preferably from 11 to 50% by weight, particularly preferably from 20 to 40% by weight.

In an embodiment of the present invention, wafer serves as the continuous phase in an aqueous dispersion according to the invention.

In an embodiment of the present invention, aqueous dispersions according to the invention may comprise at least one further hydrophobic compound (C), for example a linear or cyclic silicone compound, a polyethylene wax, a paraffin which is solid at room temperature or a partly oxidized polyethylene, for example having an acid number in the range of from 20 to 200 mg KOH/g determined according to DIN 53402.

In a preferred embodiment of the present invention, hydrophobic compound (C) is selected from silicone oils and liquid paraffins.

In another embodiment of the present invention, aqueous dispersions according to the invention comprise no further hydrophobic compound (C).

In an embodiment of the present invention, an aqueous dispersion according to the invention may also comprise, as an impurity, starting materials from the synthesis of emulsifier (B), for example (co)polymer (a), functionalized (co)polymer from step (b) and monoalkyl-capped polyalkylene glycol having on average from 5 to 1000 alkylene oxide units per molecule.

The present invention furthermore relates to a process for the preparation of aqueous dispersions according to the invention. For the preparation of aqueous dispersions according to the invention, (co)polymer (A), emulsifier (B). If appropriate further hydrophobic compound (C) and water are mixed with one another.

In an embodiment of the present invention, after mixing (co)polymer (A), emulsifier (B), if appropriate further hydrophobic compound (C) and water, the aqueous dispersion according to the invention is passed through a gap homogenizer.

Preferably, for the preparation of aqueous dispersions according to the invention, it is possible to adopt a procedure in which at least one (co)polymer A is dissolved in one or more organic solvents, at least one emulsifier (B) and water are then added and the organic solvent or solvents is or are then removed, for example by stripping with steam or nitrogen, and in particular distilled off.

Suitable organic solvents are aliphatic and aromatic hydrocarbons which are liquid at room temperature. Aliphatic solvents liquid at room temperature may be selected, for example, from cyclohexane, cycloheptane, n-haxane, n-heptane, isododecane, n-decane, n-octane, isooctane. Aromatic solvents liquid at room temperature may be selected, for example, from benzene, preferably mono- or polyalkylated aromatic solvents, such as, for example, toluene, ethylbenzene, cumene, ortbo-xylene, meta-xylene, para-xylene and isomer mixtures of xylene.

If it is desired to distill off the organic solvent or solvents, the distillation can be carried out, for example, at reduced pressure.

In a preferred embodiment of the present invention, the distillation is carried out as a steam distillation.

The present invention furthermore relates to the use of aqueous dispersions according to the invention as building auxiliary material. A further subject is a process for the production of building materials using at least one dispersion according to the invention.

If it is desired to use a dispersion according to the invention as a building auxiliary material for the production of building materials, the imparting of water repellency to gypsum, stone, clinker, mortar and concrete is preferred. For this purpose, the dispersion according to the invention is introduced into, for example, mortar or concrete raw material; for example, if can be mixed with wafer, cement, in particular Portland cement and, if appropriate, sand. It is also possible to mix gypsum powder with wafer and dispersion according to the invention and to apply a material thus obtainable to a wall.

The present invention furthermore relates to a building material produced using at least one dispersion according to the invention.

The present invention furthermore relates to structures produced using at least one dispersion according to the invention and preferably using at least one building material according to the invention. An excellent water repellant effect is observed in each case without the mechanical properties, such as, for example, flexural tensile strength and compressive strength significantly declining in comparison with building material which has not been rendered water repellant.

Even when a dispersion according to the invention is subsequently applied to wails of structures comprising, for example, stone, clinker or gypsum, for example by brushing, spraying or impregnating and subsequently allowing to dry, an excellent water repellant effect is obtained.

The present invention furthermore relates to the use of dispersions according to the invention for the production of leather. The present invention furthermore relates to a process for the production of leather using at least one dispersion according to the invention. The present invention furthermore relates to leathers produced according to the invention. The present invention furthermore relates to articles of apparel, furniture or interior automotive parts produced using leather according to the invention.

If it is desired to use dispersions according to the invention for the production of leather, it is preferable to employ one or more emulsions according to the invention, for example in tanning or preferably in retanning or imparting of water repellency. Such a process according to the invention for tanning, retanning or imparting water repellency to leather is also referred to below as tanning process according to the invention, retanning process according to the invention and leather hydrophobing process according to the invention.

The tanning process according to the invention is generally carried out by adding dispersion according to the invention in one portion or in a plurality of portions immediately before or during the tanning. The tanning process according to the invention is preferably carried out at a pH of from 2.5 to 4, it frequently being observed that the pH increases by about 0.3 to three units while the tanning process according to the invention is being carried out. The pH can also be increased by about 0.3 to three units by adding basifying agents.

The tanning process according to the invention is carried out in general at temperatures of from 10 to 45° C., preferably at from 20 to 30° C. A duration of from 10 minutes to 12 hours has proven useful, from one to three hours being preferred. The tanning process according to the invention can be carried out in any desired vessels customary in tanning, for example by drumming in barrels or in rotated drums.

In a variant of the tanning process according to the invention, emulsion or dispersion according to the invention is used together with one or more conventional tanning agents, for example with chrome tanning agents, mineral tanning agents, preferably with syntans, polymer tanning agents or vegetable tanning agents, as described, for example, in Ullmann's Encyclopedia of Industrial Chemistry, volume A15, pages 259 to 282 and in particular page 288 et seq., 5th edition, (1990), Verlag Chemie Weinheim.

In an embodiment of the tanning process according to the invention, dispersion according to the invention can be used together with one or more fatliquoring agents and water repellants.

In another embodiment of the tanning process according to the invention, the use of further fatliquoring agents and water repellants is dispensed with.

The process according to the invention for the treatment of leather can preferably be carried out as a process for the retanning of leather using a dispersion according to the invention. The retanning process according to the invention starts from semi-finished products tanned conventionally i.e. for example with chrome tanning agents, mineral tanning agents, preferably with polymer tanning agents, aldehydes, syntans or resin tanning agents. According to the invention, for carrying out the retanning process according to the invention, dispersion according to the invention as such or preferably in a form diluted with water, is allowed to act on semi-finished products.

The retanning process according to the invention can be carried out under conditions otherwise customary in tanning. Expediently, one or more, i.e. 2 to 6, exposure steps are chosen and washing with water can be effected between the exposure steps. The temperature during the individual exposure steps is in each case in the range of from 5to 60° C., preferably from 20 to 45°.

In an embodiment of the retanning process according to the invention, further fatliquoring agents and water repellants may be used.

In another embodiment of the retanning process according to the invention, the use of further fatliquoring agents and water repellants is dispensed with.

Dispersion according to the invention can be metered in the range of from 0.5 to 10% by weight, percent by weight being based on the shaved weight of the leather treated according to the invention or of the semi-finished products treated according to the invention.

For carrying out the tanning process or retanning process according to the invention, it is of course possible to add compositions usually used during tanning or retanning, for example fatliquors, polymer tanning agents, acrylate and/or methacrylate-based or silicone-based fatliquoring agents, retanning agents based on resin and vegetable tanning agents, fitters or leather dyes or combinations of at least two of the abovementioned substances.

In an embodiment of the present invention, from 0.01 to 10% by weight of dispersion according to the invention, based on the shaved weight, are used.

The invention is illustrated by examples.

### I. Preparation of an Emulsifier B.1

641 g of PIBSA (hydrolysis number HN=87.5 mg KOH/g, Mₙ=1282 g/mol; polydispersity 1.6) were initially taken with 500 g of polyethylene oxide monomethyl ether, Mₙ about 1000 g/mol, in a 2 l three-necked flask having an internal thermometer, dropping funnel and nitrogen valve. During heating to 80° C., evacuation and filling with nitrogen were effected three times in succession. The reaction mixture was then heated to 130° C. and kept at this temperature for 2 hours. If was then allowed to cool to room temperature.

IR-spectrum (KBr) in cm⁻¹:
OH stretching vibration at 3310; C—H stretching vibration at 2955, 2892, 2745;
C═O stretching vibration at 1740; C═C stretching vibration at 1641; further vibrations of the PIB skeleton: 1472, 1391, 1365, 1234; ether vibration of Pluriol at 1110.

¹H-NMR-spectrum (CDCl₃, 500 MHz, TMS, room temperature) in ppm:
4.9-4.7 (C═C of PIBSA); 4.3-4.1 (C(O)—C—CH₂—CH₂—); 3.8-3.5 (O—CH₂—CH₂—O, PEG chain); 3.4 (O—CH₃); 3.1-2.9; 2.8-2.4; 2.3-2.1; 2.1-0.8 (methylene and methine of the PIB chain).

The emulsifiers B.2 to B.4 were prepared analogously to the preparation of emulslfier B.1 by reacting the components stated in table 1.

TABLE 1
Preparation of emulsifiers B.1 to B.4
Emulsifier B.1 to B.4

| | PIBSA | Polyethylene oxide monomethyl ether |
|---|---|---|
| No. | HN [mg KOH/g] | Mₙ [g/mol] |
| B.1 | 87.5 | 1000 |
| B.2 | 87.5 | 500 |
| B.3 | 162 | 1000 |
| B.4 | 162 | 500 |

### II. Preparation of a Dispersion D-1 According to the Invention

55.4 g of emulsifier (B.1) as a solution in 36.9 g of ortho-xylene and 221.6 g of polyisobutene (A.1) (Mₙ=1000 g/mol) were stirred in a 2 l stirred kettle and heated to 90° C. with stirring. 703 g of water and 2.8 mg of H(OCH₂CH₂)₃O—(CH₂)₃— Si(CH₃)[OSi(CH₃)₃][OSi(CH₃)₂Osi(CH₃)₃] were added in the course of 10 minutes and the ortho-xylene was then removed by steam distillation. The mixture was allowed to cool to 90° C. 2.5 g of 25% by weight aqueous sodium hydroxide solution were then added. The mixture was then allowed to cool to room temperature. Aqueous dispersion D-1 according to the invention, having a pH of 7.3, a particle diameter (number average) of 460 nm (hydrodynamic flow analysis) and a solids content of 29.1%, was obtained.

The dispersions D-2 to D-4 were prepared analogously to dispersion D-1 from the emulsifiers stated in table 1 and (co)polymer (A.1).

For the preparation of dispersion D-5, 55.4 g of emulsifier (B.1) and 221.6 g of polyisobutene (A.1) (Mₙ=1000 g/mol) were stirred into 703 g of water and homogenized using a gap homogenizer.

TABLE 2
Composition of aqueous dispersions according to the invention

| Dispersion no. | (Co)polymer | Emulsifier |
|---|---|---|
| D-1 | (A.1) | B.1 |
| D-2 | (A.1) | B.2 |
| D-3 | (A.1) | B.3 |
| D-4 | (A.1) | B.4 |
| D-5 | (A.1) | B.1 |

### III. Production of a Building Material According to the Invention

Mortar was produced as described in DIM EN 196-1: 2005 (test method for cement, part 1: determination of the strength):

Half a part by weight of water (water/cement ratio WC=0.50) and one part by weight of Portland cement (CEM I 52.6 R from Milke.) were introduced into a mixing bowl and mixed at 140 rpm. After 30 seconds three parts by weight of “CEN standard sand, DIN EN 196-1” were added uniformly over a period of 30 seconds and mixing was continued for a further 30 seconds at 285 rpm.

In those cases where it was desired to additize with aqueous dispersion D-1 according to the invention or a comparative dispersion as building auxiliary material, the abovementioned amounts of water were reduced according to the water content of the relevant dispersion so that the respective total water/cement ratio was maintained.

Thereafter the mixer was stopped for 90 seconds and during the first 30 seconds, the mortar which was stuck to the wall and to the lower part of the bowl was removed with a rubber or plastic scraper and added to the middle of the bowl; mixing was then continued for 60 seconds at 285 rpm.

Thereafter, if appropriate, an aqueous dispersion (aqueous dispersion D-1 according to the invention or a comparative dispersion) as building auxiliary material and if appropriate, one or more further additive were added to the standard mortar as described above and stirring was then effected for two minutes at 285 rpm.

Further additives:

0.2% by weight of mono-n-octadecanol-capped polyethylene glycol, Brookfield viscosity; 350 mPa·s at 20° C., acid number: 8 mg KOH/g according to EN ISO 3682, as an antifoam.

0.2% by weight of aqueous solution (solids content 40%) of polymethacrylic acid, esterified with monomethyl-capped polyethylene glycol, Brookfield LVT viscosity, spindle 2, 60 min⁻¹: 200 mPa·s at 23° C. according to DIN 53018, as a flow improver.

On the basis of DIN EN 196-1: 2005, prism-shaped test specimens having the dimensions 10 mm·40 mm·160 mm were produced, removed from the moid after 24 hours and, prior to testing, stored at room temperature over the period stated in table 3. Thereafter, the flexural tensile strength (FTS) and the compressive strength (CS) were determined according to DIN EN 196-1: 2005.

TABLE 3
Composition of mortars and their performance characteristics

| | | | Amount of | | | | |
|---|---|---|---|---|---|---|---|
| | | Building | building | FTS | FTS | CS | CS |
| | | auxiliary | auxiliary | [N/mm²] | [N/mm²] | [N/mm²] | [N/mm²] |
| Mortar | WC | material | material | 7 d | 28 d | 7 d | 28 d |
| C3.1 | 0.45 | none | — | 4.6 | 5.3 | 23.8 | 25.2 |
| C3.2 | 0.50 | none | — | 3.6 | 5.3 | 18.2 | 24.1 |
| C3.3 | 0.45 | none | — | 3.9 | 6.4 | 19.4 | 21.7 |
| 3.4 | 0.45 | D-1 | 2.2 | 5.9 | 6.1 | 20.3 | 21.7 |
| C3.5 | 0.45 | PDMS 1 | 1.0 | 4.4 | 5.4 | 17.5 | 20.3 |
| C3.6 | 0.45 | PDMS 1 | 2.0 | 3.9 | 5.3 | 14.8 | 18.5 |
| C3.7 | 0.45 | PDMS 2 | 1.0 | 3.6 | 3.6 | 13.1 | 10.3 |
| C3.8 | 0.45 | PDMS 2 | 2.0 | 3.7 | 3.5 | 13.7 | 11.1 |
| 3.9 | 0.45 | D-1 | 1.3 | n.d. | n.d. | n.d. | n.d. |
| 3.10 | 0.45 | D-1 | 2.5 | n.d. | n.d. | n.d. | n.d. |

The amount of building auxiliary material is stated in % by weight, based on total mortar
WC: water/cement ratio
FTS: flexural tensile strength
CS: compressive strength

The comparative building auxiliary materials are;
PDMS 1: anionic silicone rubber emulsion obtained by emulsion polymerization and based on a polydimethylsiloxane (viscosity 1 500 000 cSt at 23° C., density: 1 g/ml, pH 5.5, silicone rubber content 50% by weight).
PDMS 2: silicone/wax emulsion based on an alkyl-modified polydimethylsiloxane (viscosity 6000 mPa·s at 20° C., density: 1.0 g/ml, pH 6.5; solids content: 35% by weight).

For assessing the water repellant effect, the contact angles on mortar surfaces were determined, cf, table 4.

TABLE 4
Measurement of contact angle of water drops on the surface of
test specimens of standard mortar (WC = 0.45) treated
with additives as stated.

| | Amount of building auxiliary | |
|---|---|---|
| Mortar | material [% by wt.] | Contact angle [°] |
| C3.3 | 0 | not measurable, water penetrates |
| 3.9 | 1.3 | 112.0 |
| 3.10 | 2.5 | 114.2 |
| C3.5 | 1.0 | 94.5 |
| C3.6 | 2.0 | 98.1 |
| C3.7 | 1.0 | 97.4 |
| C3.8 | 2.0 | 100.8 |

Furthermore, the water penetration capacity over a defined period was investigated.

TABLE 5
Amount of water in ml absorbed by test specimens versus time

| | Standard mortar | | |
|---|---|---|---|
| | without building | Standard mortar + | Standard mortar |
| Days | auxiliary material | PDMS 2 (PZ = 0.10) | with D-1 (PZ = 0.13) |
| 1 | 2.8 | 0.8 | 0.3 |
| 2 | 3.2 | 0.9 | 0.4 |
| 3 | 3.6 | 1.1 | 0.5 |
| 4 | 4.0 | 1.2 | 0.6 |
| 7 | 4.8 | 1.3 | 0.7 |
| 8 | 5.2 | 1.4 | 0.8 |
| 9 | 5.2 | 1.5 | 0.8 |
| 10 | 5.6 | 1.6 | 0.9 |
| 11 | 5.6 | 1.8 | 0.9 |
| 14 | 6.4 | 1.9 | 1.1 |

### IV. Production of a Leather According to the Invention

Two commercially available cattle wet blues (from Packer, USA) were shaved to a thickness of 1.8-2.0 mm and cut into eight strips of about 1300 g each. 2% by weight of sodium formate and 0.4% by weight of NaHCO₃ and 1% by weight of a naphthalenesulfonic acid/formaldehyde condensate, prepared according to U.S. Pat. No. 5,186,846, example “Dispersant 1”, were then added to the strips in a drum (50 l) and with a liquor length of 200% by weight at intervals of 10 minutes. After 90 minutes, the liquor was discharged. The strips were then distributed over separate drums for drumming.

Together with 100% by weight of water, in each case 1% by weight of a 50% strength by weight (solids content) aqueous solution of dyes was metered into drums 1 to 4 at 25-35° C., the solids of which solution had the following composition:
70 parts by weight of dye from EP-B 0 970 148, example 2.18,
30 parts by weight of Acid Brown 75 (iron complex), Colour index 1.7.16;
and drumming was effected for 10 minutes in the drum.

Thereafter, in each case 6% by weight of dispersion according to the invention were added, as stated in table 6, and the mixture was drummed for 30 minutes in the drum. Thereafter, 5% by weight of sulfone tanning agent from EP-B 0 459 168, example K1, were added and drumming was effected for a further 30 minutes at 15 rpm in the drum. Thereafter, the strips were treated for 45 minutes with 4% by weight of vegetable tanning agent Mimosa® and 1.5% of the dye defined above. Acidification was then effected with formic acid to a pH of 3.6-3.8. After 20 minutes, the liquors were evaluated by an optical method with regard to the exhaustion and were discharged. The leathers were then washed with 200% by weight of wafer. Finally, 2% by weight of a fatliquoring agent which was prepared as described under 3, were metered into 100% of water at 50° C. After a drumming time of 45 minutes, acidification was effected with 1% by weight of formic acid.

The washed leathers were dried and staked.

The leathers 4.1 to 4.5 according to the invention had excellent fullness and softness and hand in combination with excellent penetration of the dyes into the fibers. In addition, the leathers show pronounced water repellency without having had to be treated with water repellants based on silicone compounds.

### COMPARATIVE EXAMPLE C1

For comparative example C1, the procedure was as above but, instead of the copolymer, a total of 8% by weight of the wafer repellant from V, were metered in two portions, the first 4% by weight of fatliquoring agent being metered together with Mimosa and dye while the second 4% by weight were added as above after the first acidification.

TABLE 6
Testing of performance characteristics of leathers 4.1 to 4.5 according to the
invention and comparative leather C1

| | | | | | Water | Water | |
|---|---|---|---|---|---|---|---|
| | Dispersion | | Grain | | absorption 2 h | penetration | Levelness |
| No. | (Tab. 2) | Fullness | tightness | Softness | [% by wt] | dynamic | of dyeing |
| 4.1 | D-1 | 3 | 3 | 3.5 | 49 | 180 | 2.5 |
| 4.2 | D-2 | 2 | 2.5 | 2 | 14 | 22 000 | 1.5 |
| 4.3 | D-3 | 1 | 2 | 1.5 | 12 | 28 500 | 2 |
| 4.4 | D-4 | 1 | 2.5 | 1.5 | 16 | 15 000 | 3 |
| 4.5 | D-5 | 3 | 3 | 2 | 29 | 6400 | 2 |
| C4.6 | C1 | 4 | 3.5 | 5 | 62 | 26 | 3 |

1: Determination of water absorption according to Kubelka according to DIN 53330 (5.78), Das Leder 12, 36-37, 1961, penetration time: 2 h
2: Determination of the behavior toward water under dynamic stressing in the Bally penetrometer referred to in DIN 53338/sheet 1 (4.76), Das Leder 12, 38-40, 1961, water penetration after number of flexes.

### V. Preparation of the Comparative Water Repellent for Comparative Leather C1

The following were mixed in a 2 l kettle:
230 g of a polyisobutene having Mₙ=1000 g/mol and M_{w}=2000 g/mol,
30 g of n-C₁₆H₃₇O—(CH₂CH₂O)₂₅—OH
5 g Of n-C₁₈H₃₇O—(CH₂CH₂O)₈₀—OH
40 g of oleic acid
230 g of sulfited oxidized triolein

The mixture was heated to 60° C. with stirring and 470 g of water and 10 g of n-C₁₆H₃₃O—(CH₂CH₂O)₇—OH were added. The resulting emulsion was then passed through a gap homogenizer. A white, sufficiently stable emulsion which could be used as a water repellent was obtained.

1. An aqueous dispersion comprising;
(A) at least one (co)polymer of at least one branched or straight-chain C₃₋C₁₀-alkene; and
(B) at least one emulsifier synthesized by
(a) preparation of a (co)polymers of isobutene, the (co)polymer having at least one reactive group and being selected from homo- and copolymers of isobutene and of dimers and oligomers of isobutene with vinylaromatics, C₁-C₄-alkylstyrenes, C₃₋C₆-olefins and C₅-C₁₀-isoolefins,
(b) functionalization of the (co)polymer of isobutene (a),
(c) incorporation of at least one hydrophilic unit.

2. The aqueous dispersion according to claim 1, wherein, in step (b) the (co)polymer of at least one branched or straight-chain C₃-C₁₀-alkene (A) is functionalized by an ene reaction with an anhydride of an ethylenically unsaturated C₄-C₁₀-dicarboxylic acid.

3. The aqueous dispersion according to claim 1, wherein the (co)polymer of at least one branched or straight-chain C₃-C₁₀-alkene having at least one reactive group (A) is a (co)polymer of isobutene.

4. The aqueous dispersion according to claim 1, wherein the (co)polymer of isobutene (a), the (co)polymer having at least one reactive group, is polyisobutene having one vinyl group or isobutenyl group per molecule.

5. The aqueous dispersion according to claim 1, wherein step (c) comprises reacting with at least one monoalkyl-capped polyethylene glycol.

6. The aqueous dispersion according to claim 1, wherein the proportion of (co)polymer (A) is greater than that of emulsifier (B).

7. The aqueous dispersion according to claim 1, wherein water serves as the continuous phase.

8. A process for the preparation of aqueous dispersions according to claim 1, wherein at least one (co)polymer (A) is dissolved in one or more organic solvents, at least one emulsifier (B) and water are added and the organic solvent or solvents is or are removed.

9. The process according to claim 9, wherein the organic solvent or solvents is or are distilled off by steam distillation.

10. The process according to claim 8, wherein organic solvent is selected from mono- or polyalkylated aromatic solvents.

11. (canceled)

12. A process for the production of building materials using at least one dispersion according to claim 1.

13. A structure produced using at least one dispersion according to claim 1.

14. A structure produced using at least one building material produced by a process according to claim 13.

15. (canceled)

16. A process for the production of leather using at least one dispersion according to claim 1.

17. A leather produced by a process according to claim 16.

18. An article of apparel, piece of furniture or interior automotive part produced using a leather according to claim 17.

19. A building auxiliary material produced by a process according to claim 12.

20. The aqueous dispersion according to claim 2, wherein the (co)polymer of isobutene (a), the (co)polymer having at least one reactive group, is polyisobutene having one vinyl group or isobutenyl group per molecule.

21. The aqueous dispersion according to claim 3, wherein the (co)polymer of isobutene (a), the (co)polymer having at least one reactive group, is polyisobutene having one vinyl group or isobutenyl group per molecule.

22. The aqueous dispersion according to claim 2, wherein the (co)polymer of isobutene (a), the (co)polymer having at least one reactive group, is polyisobutene having one vinyl group or isobutenyl group per molecule.
